(19) United States
(12) Patent Application Publication
(10) Pub. No.: US 2019/0328172 A1
(43) Pub. Date: Oct. 31, 2019

(54) BEVERAGE MAKER FOR PREPARING HOT DRINKS AND USE THEREOF

(71) Applicant: WMF Group GmbH, Geislingen/Steige (DE)

(72) Inventors: Alexander Kiefer, Kuchen (DE); Armin Startz, Weidenstetten (DE)

(73) Assignee: WMF Group GmbH, Geislingen/Steige (DE)

(21) Appl. No.: 16/479,327

(22) PCT Filed: Jan. 17, 2018
(86) PCT No.: PCT/EP2018/051062

§ 371 Date: Jul. 19, 2019

(30) Foreign Application Priority Data
Jan. 20, 2017 (DE) 10 2017 200 950.0

(51) Int. Cl. A47J 31/52; H02J 3/32; H02J 9/06; H02J 7/04; A47J 31/44

(52) U.S. Cl. CPC A47J 31/521; H02J 3/32; A47J 31/441; H02J 7/04; H02J 9/061

(57) ABSTRACT

A beverage maker for the preparation of hot beverages is provided that includes a connector for an external power supply having a first electrical power, at least one rechargeable storage unit for electrical energy having a second electrical power, a transformer that is electrically connected to the connector for an external power supply and to the rechargeable storage unit for electrical energy, and at least one high-performance electrical consumer for heating water, wherein the at least one high-performance electrical consumer has an electrical connection to the rechargeable storage unit for electrical energy and is supplied with electrical energy by it. Very high powers can be permanently provided at the high-performance consumer by the beverage maker in accordance with the invention, with the external power supply not being temporarily subjected to loads by high power peaks.

### CROSS-REFERENCE TO RELATED APPLICATIONS

This application is a 371 nationalization of international patent application PCT/EP2018/051062 filed Jan. 17, 2018, which claims priority under 35 USC § 119 to Germany patent application 10 2017 200 950.0 filed Jan. 20, 2017. The entire contents of each of the above-identified applications are hereby incorporated by reference.

### BRIEF DESCRIPTION OF THE DRAWINGS

FIG. 1 shows an electrical wiring diagram for an example of a beverage maker in accordance with the invention;

FIG. 2 shows an electrical wiring diagram for a second example of a beverage maker in accordance with the invention;

FIG. 3 shows an electrical wiring diagram for a third example of a beverage maker in accordance with the invention; and

FIG. 4 shows an electrical wiring diagram for a fourth example of a beverage maker in accordance with the invention.

### DETAILED DESCRIPTION

A beverage maker for the preparation of hot beverages is provided that includes a connector for an external power supply system having a first electrical power, at least one rechargeable storage unit for electrical energy having a second electrical power, a transformer that is electrically connected to the connector for an external power supply system and to the rechargeable storage unit for electrical energy, and at least one electrical high-performance consumer for heating water, wherein the at least one electrical high-performance consumer has an electrical connection to the rechargeable storage unit for electrical energy and is supplied with electrical energy by it. Very high powers can be permanently provided at the high-performance consumer by the beverage maker in accordance with the invention, with the external power supply system not being temporarily subjected to loads by high power peaks. A uniform consumption of relatively low electrical power from the external power supply system can rather take place to charge the at least one rechargeable storage unit of the beverage maker and to ensure that it is permanently suitable to provide high electrical powers to the high-performance consumer.

Apparatus for the preparation of beverages typically include a plurality of electrical consumers. In this respect, power-intensive consumers (e.g. heating units for boilers, heating units for steam boilers or for continuous-flow water heaters) are as a rule connected to the power supply at the primary side. Powers of several kilowatts are often required for the dispensing of hot beverages in this process. Water for tea is, for example, dispensed at speeds around 30 ml/s in coffee makers for gastronomy. A parallel dispensing of, for example, brewing water and also steam (e.g. to foam milk) additionally often takes place.

If the sum of the energy output at a specific point in time is taken from these consumers, it becomes clear that it is considerably above the typically available power of the power supply line at the installation sites. In central Europe, it e.g. amounts to around 3 kW with a typical domestic supply and on the use of a single phase. The dispensing of such large amounts of energy is thus only made possible in that large amounts of energy are buffered by means of quantities of hot water or of pressurized superheated water in boiler systems and steam boiler systems.

The brewing water of a coffee maker as a beverage maker has, for example, to be heated from an inflow water temperature (typically 15° C.) to 90° C. (brewing water temperature). An average cup of coffee contains 125 ml. An amount of energy of 40 kJ is thus required to brew a single cup. Assuming an average brewing time of 20 sec., a heating element (e.g. a continuous-flow water heater) is required for a beverage maker without an energy store (e.g. without a hot water reservoir) that can provide a heating power of approximately 2 kW without any support. If 200 ml of hot water is now simultaneously dispensed into a glass for tea water at a fast dispensing speed of 25 ml/s, a further 63.6 kJ of heating energy and thus 8 kW of heating power are required. It is understood that this electrical power of in total 10 kW cannot be drawn at a conventional single phase power system with a maximum power rating of 3 kW.

A possibility of solving this problem that is used in the prior art is represented by thermal energy buffers (e.g. in the form of hot water reservoirs). They are used, for example, in coffee makers with continuous-flow water heaters to reduce the amount of energy required directly on the dispensing of the beverage. Energy buffers such as hot water reservoirs have to be heated at the start of operation and emit thermal energy by radiation and convection during operation. It is a disadvantage in this respect that the thermal energy buffers have a high mass (e.g. a large water volume) and their stored (residual) energy is slowly output to the environment after the beverage maker has been switched off, e.g. after its daily end of operation. Large coffee makers here frequently have a water store of more than 2 liters reservoir content, which on its own already requires approximately 636 kJ of energy for the heating procedure of the water. This energy is lost after the coffee maker is switched off.

Electrical consumers are also integrated in beverage makers that are typically connected to the secondary side. Transformers or switching power supplies are required for the operation of these components and convert the line voltage at the primary side into low voltage. The switching power supply or the transformer here has to have a size dimensioned such that all the electrical consumers running in parallel can be simultaneously controlled. Since in particular DC motors have a much higher start-up power as their rated current, the transformers have to be considerably overdimensioned or an energy management in the central control unit of the beverage maker has to ensure that these switch-on times do not overlap and result in an overload of the switching power supply or transformer.

The electrical consumers can be low voltage consumers. The CPUs that control beverage makers work, for example, exclusively with low voltage (as a rule 3.3 V to 5 V). For safety reasons, such low voltage consumers in beverage makers are supplied with a DC low voltage of 12 V to 60 V. Transformers, power supply units and/or switching power supplies that transform the voltage at the primary side into a safety low voltage at the secondary side are used both the for the control and energizing of the consumers and for the electrical energy supply of low voltage components.

However, the higher the total power required by the beverage maker is, the higher the space requirements in the interior of the beverage maker to accommodate the transformers, power supply units and/or switching power supplies. The demands on these elements to satisfy the required safety standards furthermore also rise proportionally to the required power. It is therefore desirable to have as much space as possible available for such elements in the interior of the beverage maker with a predefined size of the beverage maker.

Due to their internal circuits, beverage makers from the prior art are furthermore not suitable to generate an electrical heating power during operation via an external power supply system (grid operation) that exceeds the maximum drawable power of the external power supply system.

A number of electrical consumers in beverage makers from the prior art are often only in operation for a few seconds with peak currents of even shorter times in part for the dispensing of a hot beverage. Switching power supplies and/or transformers have to be designed for these high currents even though they are as a rule only in use for very brief periods. In addition to the construction space of the machine, this also increases the required use of resources to manufacture such transformers.

It is furthermore not allowed to generate short heating power peaks (e.g. at a water heater) in a rapid manner without restrictions in known beverage makers in grid operation since current pulses are required for this purpose that can be switched very fast. The reason for this is that the current pulses that can be switched fast have repercussions on the grid voltage. The repercussion on the power supply system in turn causes different illumination levels (flickers) in lamps in the power supply system. Limit values and tests for these effects are described in standards (e.g. DIN EN 61000-3-3).

There is thus a need for a beverage maker that can provide an electrical output power for high-performance consumers (e.g. a heating unit) that is higher than the electrical power drawable at a maximum from the external power supply system in a permanent and sparing manner.

The comfort in operation of beverage makers is furthermore becoming more and more important for users. The beverage makers should thus be able to be switched on, operated, switched off, and reachable at all times remotely or via a time switch at a desired point in time. Additional small transformers or switching power supplies that permanently supply the control of the beverage maker with energy for a “wake-on-LAN” have to be used to lower the power consumption in the standby state of the beverage maker for this purpose. There is thus additionally a need in the prior art for a beverage maker that does not have to take any power from the power supply system in the standby state and that thus relieves the pressure on the power supply system in this state. Such beverage makers should additionally also be reachable at all times (independently of the current switch-on state) for a remote service even without a defined ON state.

DE 10 2007 012 231 B3 describes a mobile hot water heater, wherein hot water is provided in a storage container by the energy from a combination of a fuel cell and a rechargeable battery. The rechargeable battery here provides the required energy for a short-term, high energy requirement and the fuel cell is used to recharge the rechargeable battery. This hot water heater has a high weight due to the integrated water tank and a lot of energy additionally has to be used to heat the water in the water tank to the desired temperature. This energy is output to the environment at the end of operation and is thus lost, i.e. is no longer available for the preparation of beverages.

U.S. Pat. No. 6,123,010 A likewise describes a mobile beverage maker, wherein hot water is provided in a storage container by the energy from a rechargeable battery, a power system, a cigarette lighter, a wind generator, or a solar module. It is disadvantageous here that the beverage maker has a high weight due to the water storage container and the water inside the tank first has to be laboriously heated by the energy source so that the beverage maker is ready to use. The energy contained in the heated water is lost after a break in use of the beverage maker.

EP 1 852 043 A describes a coffee maker that is autonomously operated without an external power source from power from rechargeable batteries and fuel cells.

DE 10 2008 052 190 A1 describes a beverage maker that can be operated (autonomously) independently of the external power supply system and that includes a continuous-flow water heater to heat water, wherein the continuous-flow water heater draws electrical energy exclusively from a rechargeable battery. The rechargeable battery has a higher discharge power (more than 500 W) in comparison with the charge power (approximately 50 W). The brewing time in rechargeable battery operation is thereby comparable with a brewing time in grid operation. This beverage maker, however, has the disadvantage that it can be operated either only by energy from an external power supply system (grid operation) or by energy from a rechargeable battery (rechargeable battery operation). The heating power applied at the continuous-flow water heater is thus limited in amount and in duration by the rechargeable battery, which can above all result in insufficient heating power at the continuous-flow water heater in high (very frequent) dispensing periods over a long period and thus in quality losses of the prepared beverage, up to operation failures.

Starting from this, it was the object of the present invention to provide a beverage maker that can be configured in a construction that is as compact as possible and that allows very high electrical powers for high-performance electrical consumers to heat water to be provided without high temporary load peaks on the external power supply system.

In accordance with the invention, a beverage maker for preparing hot beverages is provided comprising
a) a connector for an external power supply system having a first maximum electrical power;
b) at least one rechargeable storage unit for electrical energy having a second maximum electrical power that is higher than the first maximum electrical power;
c) a transformer that is electrically connected to the connector for an external power supply system and to the rechargeable storage unit for electrical energy; and
d) at least one high-performance electrical consumer for heating water, wherein the at least one high-performance electrical consumer has an electrical connection to the rechargeable storage unit for electrical energy and is supplied with electrical energy by it,
   characterized in that the at least one high-performance electrical consumer for heating water has a minimum electrical power consumption that is higher than the first maximum electrical power.

The beverage maker in accordance with the invention is characterized in that it can also generate very high heating powers at the high-performance electrical consumer for heating water at short notice and in so doing does not require any energy store in the form of a hot water reservoir. In other words, limited amounts of hot water can be provided in a very short time without high-mass energy stores (water reservoirs, mass storage in general, etc.) being necessary. The beverage maker in accordance with the invention therefore does not have any energy losses due to high-mass thermal energy stores and can thus be operated with more energy economy (and thus also more ecologically) than conventional beverage makers that require such high-mass energy stores. The beverage maker can furthermore be implemented in a more compact construction.

In addition, operation is even possible with the beverage maker in accordance with the invention in the case of a low or unreliable grid supply since the rechargeable storage unit for electrical energy can bridge a low grid supply or phases of undersupply via the external grid. In this connection, it is also ensured by the beverage maker in accordance with the invention that the provision of (hot) drinks is also possible without downtimes in phases of high (highly frequent) beverage dispensing.

Voltage fluctuations (“flicker”) in the external power supply system can furthermore be avoided since the at least one high-performance electrical consumer does not draw its electrical energy for heating water of the beverage maker in accordance with the invention directly from the external power supply system, but rather internally via the at least one rechargeable storage unit for electrical energy. The rechargeable storage unit for electrical energy exerts a uniform load on the power supply system during its charging procedure and fast heating power peaks only put a load on the rechargeable storage unit, but not on the external power supply system. To this extent, the rechargeable storage unit has a compensating effect (“buffer effect”) with respect to the external power supply system.

The beverage maker in accordance with the invention can be characterized in that the connector for the electrical power supply system
i) is a connector for an AC power supply system, preferably an AC power supply system having an AC voltage per phase in the range from 100 V to 255 V, and particularly preferably at a frequency of 50 to 60 Hz; and/or
ii) is suitable, together with the electrical power supply system, to provide an electrical power per phase of more than 0.5 kW, preferably of at least 1 kW, particularly preferably of at least 1.5 kW, very particularly preferably 2 kW, and in particular of at least 2.5 kW, optionally of at least 3 kW; and/or
iii) is connected to the electrical power supply system.

The beverage maker can include at least one charge regulator that is suitable to convert voltage applied to the connector for an external power supply system such that the at least one electrical energy store (optionally also at least one further electrical energy store) can be charged. The charge regulator can have an electrical connection to the connector for an external power supply system. The charge regulator can furthermore have an electrical connection to the rechargeable storage unit for electrical energy. In addition, the charge regulator can be suitable to convert AC voltage into DC voltage, optionally into a pulsating or smoothed DC voltage.

A preferred embodiment is characterized in that the rechargeable storage unit for electrical energy is suitable to provide DC voltage, in particular a voltage from 5 to 100 V, preferably from 10 to 60 V, particularly preferably from 15 to 42 V (safety low voltage), and in particular a safety low voltage in the range from 24 to 40 V. This has the advantage that there is much less risk for the involved persons on the operation and also on the servicing of the beverage maker of being exposed to an electric shock that is hazardous to health. As a result, safety is improved for service engineers in the event of a repair measure at the beverage maker and the measures for the electrical insulation of the beverage maker fall dramatically. If, for example, it is desired to operate a high-performance electrical consumer for heating water in the low voltage range only over an external power supply system and not over a rechargeable energy store for electrical energy, several kilowatts would thus be required in the low voltage range and thus very large transformers would be required. An integration of such transformers is not necessary in accordance with the invention, whereby the costs for the beverage maker can be lowered, the beverage maker can be configured as more compact, and heating powers that considerably exceed the maximum possible heating power of transformed grid voltage can be drawn.

In a preferred embodiment, the rechargeable storage unit for electrical energy is suitable to output an electrical power that corresponds to at least 1.5 times, preferably at least 2 times, particularly preferably at least 4 times, very particularly preferably at least 6 times, in particular at least 8 times, optionally at least 10 times, the first electrical power.

The rechargeable storage unit for electrical energy can furthermore be suitable to provide an electrical power of more than 0.75 kW, preferably at least 2 kW, particularly preferably at least 6 kW, very particularly preferably at least 12 kW, in particular at least 20 kW, optionally at least 30 kW.

The rechargeable storage unit for electrical energy can furthermore have a storage capacity that is suitable to carry out one to five, preferably one to four, particularly preferably two to three, brewing cycles before a recharging of the rechargeable storage unit becomes necessary.

The storage capacity of the rechargeable storage unit for electrical energy can amount to more than 0 and less than 100 Wh, preferably 1 to 8 Wh, particularly preferably 2 to 60 Wh, in particular 3 to 22 Wh,

In an exemplary embodiment, the storage unit has a dimensioning of 2000 W×20 s=40 kWs. This means a storage capacity of approximately 0.5 Ah (12 Wh) with a 24 V voltage supply. This storage capacity is sufficient to supply at least one high-performance electrical consumer for heating water for a plurality of consecutive preparations of hot beverages (brewing cycles) with electricity.

As a further example, a heating energy of approximately 11 kJ is required for the preparation of an espresso having 35 ml of water that has to be heated from 15° to 90° C. This corresponds to a required capacity of the storage unit of 3 Wh. The preparation of 250 ml of water for tea that is likewise heated by way of example from 15° C. to 90° C. can be named as a further example. A capacity of the storage unit of around 22 Wh would be required for one beverage for this purpose. The charging of the storage unit in particular takes place during pauses and secondary times and can also take place during the preparation of the hot beverage (i.e. can additionally be supported by the grid supply at this point in time). Since the dispensing of water for tea takes place very fast in relation to coffee beverages (without secondary times such as the supply of the brewing unit with ground coffee), a larger storage may be necessary here in dependence on the embodiment to dispense a certain number of beverages. This would then be a multiple of the exemplary 22 Wh (e.g. over 100 Wh for the dispensing of 5 beverages consecutively).

The rechargeable storage unit for electrical energy can be selected from the group comprising an electrical rechargeable storage unit, an electrochemical rechargeable storage unit, and combinations thereof, is preferably selected from the group comprising a rechargeable battery, a reverse fuel cell, a capacitor, and combinations thereof, and is particularly preferably selected from the group comprising an Li-ion battery, a lead acid battery, a supercapacitor, and combinations thereof.

The at least one rechargeable storage unit is advantageously replaceable and is preferably replaceably arranged in, at or next to the beverage maker. Particularly in the case of foreseeably long operating times (peak operating times), it is advantageous if the rechargeable storage unit can be replaced with a rechargeable storage unit having a greater capacity or with further storage elements for electrical energy. The machine can thus be ideally configured for a plurality of customers and this store can be expanded for a smaller group of customers for whom the beverage maker has to withstand longer peak operating times without interruption.

The beverage maker can furthermore include at least one further rechargeable storage unit for electrical energy that is preferably electrically connected to the connector for an external power supply system via a further transformer.

The at least one further rechargeable storage unit for electrical energy can further be electrically connected to the at least one rechargeable storage unit for electrical energy.

The further rechargeable storage unit for electrical energy can furthermore be suitable to provide DC voltage, in particular a voltage from 5 to 100 V, preferably from 10 to 60 V, particularly preferably from 15 to 42 V (safety low voltage), in particular a safety low voltage in the range from 24 to 40 V.

In addition, the further rechargeable storage unit for electrical energy can be suitable to output an electrical power that is larger than 0 and less than 75%, preferably less than 50%, particularly preferably less than 25%, very particularly preferably less than 15%, in particular less than 12%, optionally less than 10%, of the first electrical power.

The further rechargeable storage unit for electrical energy can furthermore be suitable to output an electrical power that is greater than 0 and less than 1 kW, preferably 0.2 to 0.9 kW, particularly preferably 0.3 to 0.8 kW, very particularly preferably 0.4 to 0.7 kW, in particular 0.5 to 0.6 kW.

In a preferred embodiment, the further rechargeable storage unit for electrical energy has a storage capacity that is higher than the storage capacity of the rechargeable storage unit for electrical energy, preferably a storage capacity of at least 10 Wh, preferably at least 50 Wh, particularly preferably at least 500 Wh, very particularly preferably at least 1 kWh, in particular at least 5 kWh. This makes it possible to charge the further rechargeable storage unit for electrical energy (e.g. a lead acid battery) slowly while short-term, very high electrical powers can be drawn from the storage unit for electrical energy (e.g. a lithium ion battery or an electrical capacitor) (that can be completely charged faster).

The at least one further rechargeable storage unit for electrical energy can, however, generally also have the same features as the rechargeable storage unit for electrical energy that is included in accordance with the invention in the beverage maker.

The further rechargeable storage unit for electrical energy can thus also be selected from the group comprising an electrical rechargeable storage unit, an electrochemical rechargeable storage unit, and combinations thereof, is preferably selected from the group comprising a rechargeable battery, a reverse fuel cell, a capacitor, and combinations thereof, and is particularly preferably selected from the group comprising an Li-ion battery, a lead acid battery, a supercapacitor, and combinations thereof.

It is possible that the further rechargeable storage unit for electrical energy is an electrochemical rechargeable storage unit (e.g. a rechargeable battery and/or a reverse fuel cell) and that the rechargeable storage unit for electrical energy is an electrical rechargeable storage unit (e.g. a capacitor).

It is advantageous if the beverage maker can be operated at a charge power up to 3 kW, preferably in the region from 1 kW to 1.3 kW, since the beverage maker can thus also be sufficiently supplied with approximately 1300 W (in Japan) and 1500 watts (in the USA) in countries with low single-phase grid supplies (e.g. 100 V in Japan or 120 V in the USA) with maximum dispensing power. It would thus be possible, for example, with an exemplary power rating of 1 kW to buffer the heating energy of 2 kW in each case for 20 seconds over a cycle of one minute. A beverage could thus be prepared at a ratio of supplied power to output power of ⅓ every 20 seconds and 20+40 seconds could be used for the charging of the store. 3 kW heating power would thus even be theoretically possible, but a certain amount of residual energy is also required for the other consumers. The consumption of electrical energy for various electrical consumers of a beverage maker is shown by way of example in Table 1.

TABLE 1
Electrical power for a brewing cycle without observing
energy-intensive consumers (heaters)

| | Control time | Current | Voltage | Power | Energy | |
|---|---|---|---|---|---|---|
| | [s] | [A] | [V] | [W] | [Ws] | [Wh] |
| Grinder | 6 | 8 | 24 | 192 | 1152 | 0.32 |
| Brewer motor | 5 | 6 | 24 | 144 | 720 | 0.20 |
| Brewer motor (pressing) | 1 | 15 | 24 | 360 | 360 | 0.10 |
| Brewing valve | 3 | 0.3 | 24 | 7.2 | 21.6 | 0.01 |
| Relief valve | 3 | 0.3 | 24 | 7.2 | 21.6 | 0.01 |
| Pump | 20 | 4 | 24 | 96 | 1920 | 0.53 |
| | | | | Total | 4195.2 | 1.17 |

70×1.17 Wh=82 Wh of energy would thus be necessary by way of example for e.g. 70 cups an hour for the low voltage consumers without a heater system. A 24 V storage module with 3.4 Ah would thus be necessary by way of example. If beverages such as milk coffee or cappuccino are prepared, additional electrical components (e.g. milk pumps or further valves) are required together with the exemplary consumers listed above. The further rechargeable storage unit should in this case optionally also be dimensioned such that sufficient energy is available for e.g. one hour of peak operation if it is not possible to regenerate this storage unit with energy in the short break times between the beverages.

The basic supply of the beverage maker with electrical power for a display unit (display), a control unit, or electrical sensors can also take place via the or via a further rechargeable storage unit. Electrical voltages of 5 V to 24 V are typically customary here. These electrical voltages can be directly provided from the rechargeable storage unit or electrical voltage regulators can be interposed to adapt the voltage.

In a preferred embodiment, the beverage maker is characterized in that the at least one high-power electrical consumer for heating water is not supplied with heat energy to heat water by a hot water container. This embodiment is advantageous since the beverage maker can thus be provided in a small construction and the heat energy required for the heating for the hot water container is not lost after switching off the beverage maker.

The at least one high-performance electrical consumer for heating water can have an electrical power consumption that corresponds to at least 1.5 times, preferably at least 2 times, particularly preferably at least 4 times, very particularly preferably at least 6 times, in particular at least 8 times, optionally at least 10 times, the first electrical power.

If a plurality of high-performance consumers are present in the beverage maker and if these high-performance consumers are electrically controlled in parallel (that is, at the same time), the sum of the electrical powers of these high-performance consumers can have the above-described minimal electrical power consumption.

The at least one high-performance electrical consumer for heating water can furthermore comprise or consist of a continuous-flow water heater, preferably a continuous-flow water heater having a heating system selected from the group comprising a thick-film heating system, a thin-film heating system, a blank film heating system, blank wire heating systems, an infrared radiation heating system, a microwave radiation heating system, a water condensation heating system and combinations thereof. The advantage of a continuous flow water heater is that it enables simple maintenance and descaling in comparison with other heating units. This is very comfortable for the user and reduces the time in which the beverage maker cannot be used for maintenance reasons. On the use of low voltages of up to 100 V, in particular for the operation of blank wire continuous-flow water heater systems, the required insulation distances can thus also be shortened.

The beverage maker can have at least one temperature sensor, wherein the at least one temperature sensor, preferably,
i) is arranged within, upstream and/or downstream of the at least one high-performance electrical consumer for heating water; and/or
ii) is configured to regulate the electrical power that is provided to the at least one high-performance electrical consumer for heating water; and/or
iii) is selected from the group comprising an NTC temperature sensor, a PTC temperature sensor, an IR sensor, a sound velocity sensor, and combinations thereof.

The beverage maker can have at least one flow sensor, wherein the at least one flow sensor, preferably,
i) is arranged within, upstream and/or downstream of the at least one high-performance electrical consumer for heating water; and/or
ii) is configured to regulate a volume flow of water in the at least one high-performance electrical consumer for heating water; and/or
iii) is selected from the group comprising a flow meter, a flow rate meter based on ultrasound, a flow rate meter based on MID, and combinations thereof.

The beverage maker can include at least one low-power consumer, optionally a plurality of low-power consumers, wherein the at least one low-power consumer is preferably selected from the group comprising a coffee grinder, a brewer motor for pressing ground coffee, a pump, a valve, a central control unit, an operating unit, and combinations thereof.

The at least one low-power consumer is furthermore preferably electrically connected to a further rechargeable storage unit for electrical energy (e.g. to one having the above-named features) and is in particular supplied with electrical energy by it.

The beverage maker can include at least one control electronics system, wherein the control electronics system is preferably suitable
i) to communicate the current charge state of the rechargeable storage unit for electrical energy, preferably to output and/or transmit information on it, particularly preferably to output information on it on a display of the beverage maker and/or to transmit it over the internet; and/or
ii) to receive a forecast for a charge requirement of the rechargeable storage unit for electrical energy from a user and/or to prepare it itself on the basis of statistics, preferably to output and/or transmit information on it, particularly preferably to output information on it on a display of the beverage maker and/or to transmit it over the internet; and/or
iii) to receive information, preferably information from a user and/or from the internet, particularly preferably information from a user and/or from the internet on a point of time when the rechargeable storage unit for electrical energy should be charged.

The above-named properties of the control electronics system naturally apply accordingly to each further rechargeable storage unit for electrical energy that is included in the beverage maker in accordance with the invention.

If the control electronics system of the beverage maker is connected to the (further) rechargeable storage unit for electrical energy, software updates are e.g. also possible remotely without the beverage maker having to be connected to the power supply or having to be switched on. The energy supplier can furthermore e.g. invoke information for influencing the charge state at the beverage maker via the power cord and/or can influence it in dependence on the energy availability.

The use of a beverage maker in accordance with the invention for preparing a hot beverage is furthermore proposed.

### REFERENCE NUMERAL LIST

1, 1′, 1″: rechargeable storage unit for electrical energy;
2: further rechargeable storage unit for electrical energy
3, 3′: electrical consumer with a high power requirement (e.g. DC motor and/or heating unit);
4, 4′, 4″, 4′″: electrical consumer with a low to medium power requirement;
5, 5′: charge regulator;
6: connector for an external power supply system (e.g. domestic power supply system);
7: external power supply system (e.g. power supply from the domestic power supply);
8: (imaginary) dividing line from the beverage maker to the external power supply system;
9: control unit;
10: wireless connection (e.g. WiFi connection);
11: internet (e.g. cloud store);
12: control electronics system;
a: electrical line;
b: electrical line;
c: electrical line;
d: electrical line;
e: electrical line;
f: communication line (e.g. data line);
g: communication line (e.g. data line);
h, h′, h″: communication line (e.g. data line);
i: electrical line.

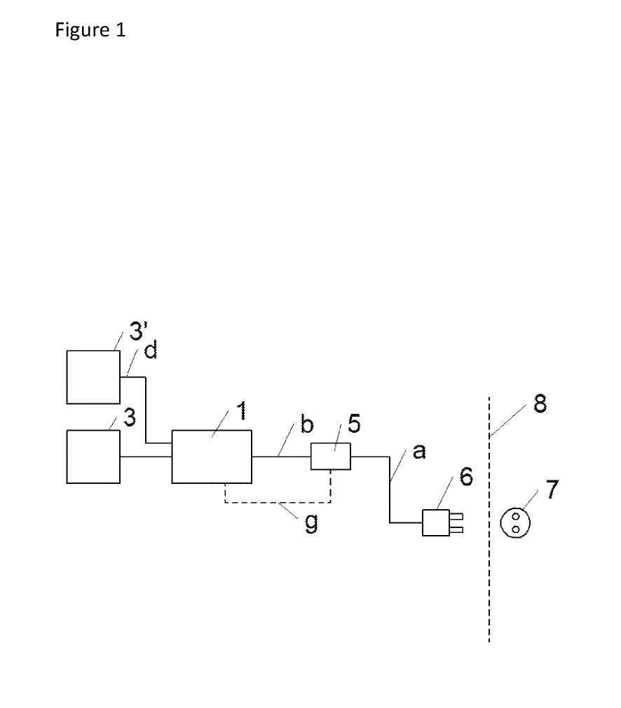

FIG. 1 shows an electrical wiring diagram in a beverage maker in accordance with the invention. The connector 6 for an external power supply system of the beverage maker is connected to an external power supply system 7 for the electrical charging of the rechargeable storage unit 1 for electrical energy. The rechargeable storage unit 1 for electrical energy is charged via a charge regulator 5 and electrical lines a, b. Electrical consumers 3, 3′ having a high, short-term power requirement are arranged at the storage unit 1 for electrical energy and are supplied with electrical power from the storage unit 1 for electrical energy via an electrical line d. The charge regulator 5 can here communicate with the storage unit 1 for electrical energy via an information line g and can thus initiate its optimum charge with reference to its state.

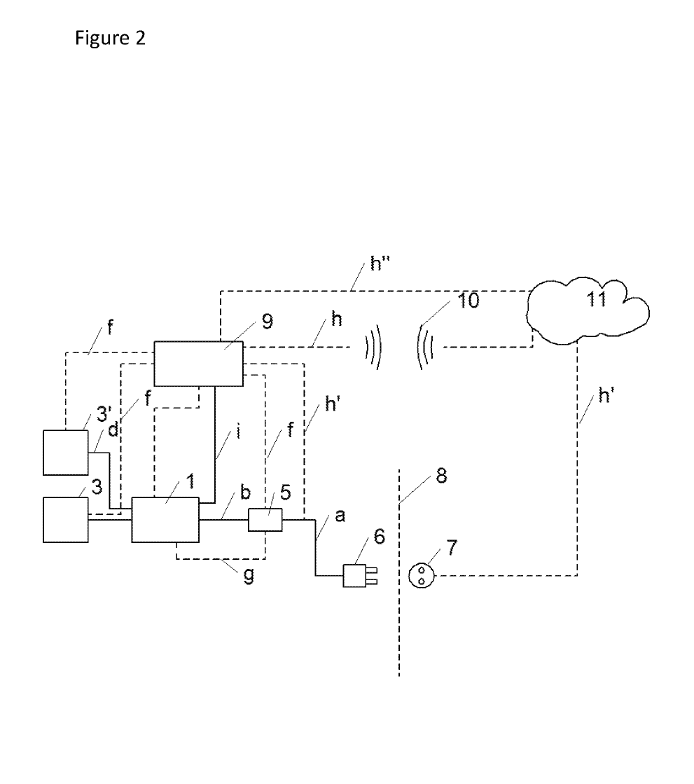

FIG. 2 shows an electrical wiring diagram in a further beverage maker in accordance with the invention. A further expansion stage of the beverage maker is shown. The beverage maker here has a control unit 9 that is configured to communicate with the rechargeable storage unit 1 for electrical energy and with electrical consumers having a high, short-term power requirement via data lines f. These components can be controlled in this process and their actual state can be detected. The control unit 9 can also be supplied by the rechargeable storage unit 1 for electrical energy in operating breaks with an interrupted grid supply. The control unit is furthermore suitable to communicate with the internet 11 via a communication line h and via a wireless connection 10. This communication can also be implemented directly via a communication line h″ (e.g. a LAN connection). With a data connection h′ (e.g. a Powerlink connection) via an electrical line a to the external power supply system 7, data can also be exchanged with the internet via the power supply system. If the data connection h′ is a Powerlink connection, a communication connection is understood by it that is modeled via the supply on the grid side and that can supply information to the control unit of the beverage maker.

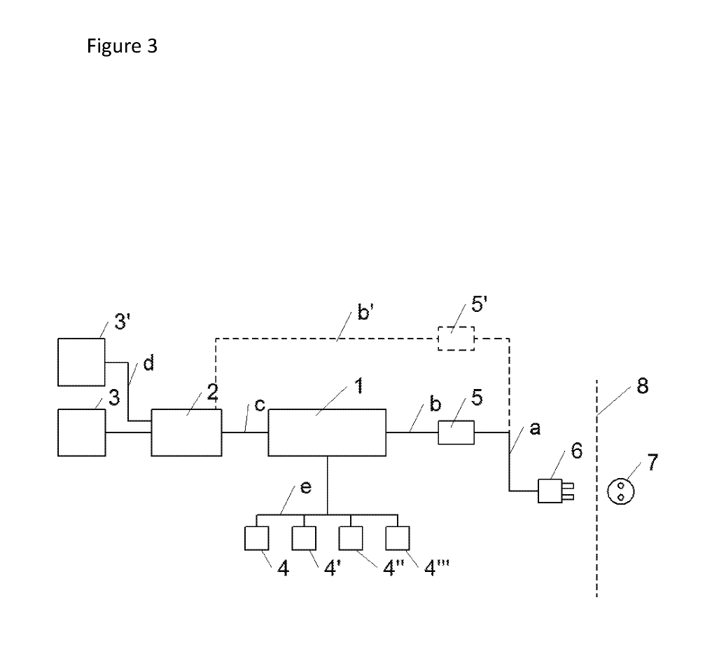

FIG. 3 shows an electrical wiring diagram in a further beverage maker in accordance with the invention. Electrical consumers 4, 4′, 4″, 4″ having a low to medium power requirement are here connected to a rechargeable storage unit 1 for electrical energy and electrical consumers 3, 3′ having a high energy requirement are connected to the rechargeable storage unit 2 for electrical energy. The energy store 2 is fed by way of example by the energy store 1. The energy store 2 can also be directly connected to a suitable charge regulator 5′ via an electrical line b′ and to the external power supply system 7 via an electrical line a in a preferred embodiment, with in this case a direct charging of the energy store 2 being able to take place by the external power supply system 7 (i.e. without buffering via the further energy store 2). An electrical connection c between the energy store 1 and the further energy store 2 is thus not necessary. The further energy store 2 can be necessary if the energy store 1 cannot provide the very high currents and powers at short notice due to its internal resistance. The further energy store 2 can be present multiple times or an individual further energy store 2 can even be provided to every consumer. Electrical consumers 4, 4′, 4″, 4′″ with medium or low power requirements can be supplied via the energy store 1. It is also possible here to take the machine off the external power supply system 7 for a limited time, depending on the capacity of the storage module, without restricting the function of the electrical consumers 4, 4′, 4″, 4′″. A higher internal resistance can here be accepted with the rechargeable storage unit 1 for electrical energy due to the slower draining and slower charging (with respect to the further rechargeable storage unit 2 for electrical energy).

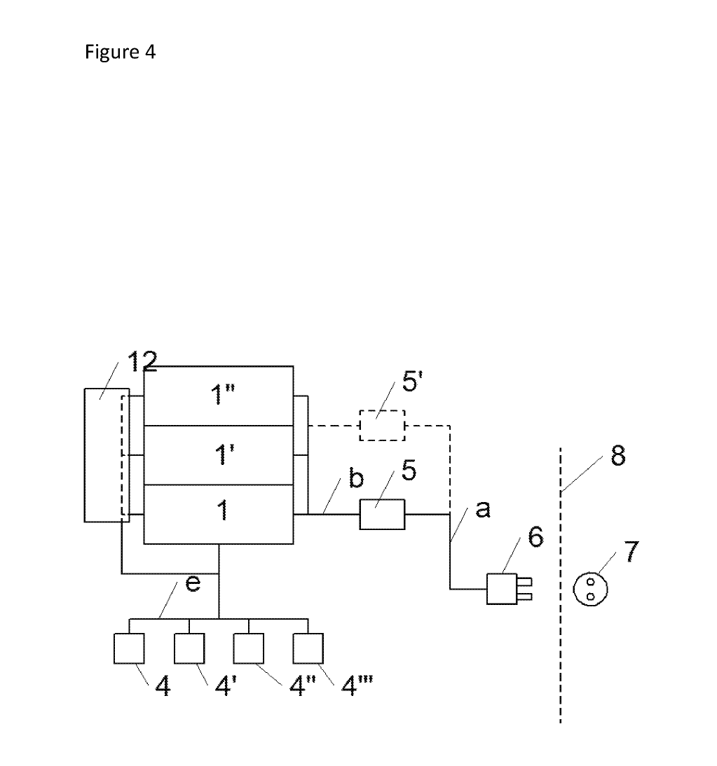

FIG. 4 shows an electrical wiring diagram in a further beverage maker in accordance with the invention. A beverage maker is schematically shown that includes a plurality of (three in total here) rechargeable storage units 1, 1′, 1″ for electrical energy that are electrically connected in parallel. They can naturally be expanded by further rechargeable storage units for electrical energy if required. This can be done, for example, in that a plurality of these rechargeable storage units for electrical energy are electrically connected in parallel. The beverage maker can include, for this purpose, a further charge regulator 5′ in addition to the charge regulator 5. An intelligent control electronics system 12 is provided at the rechargeable storage units 1, 1′, 1″ for electrical energy at the output side here and connects the respective storage units 1, 1′, 1″ for electrical energy (after one another) in dependence on their current charge state, e.g. allows their discharge.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, or N including any one element alone or the one element in combination with one or more of the other elements which may also include, in combination, additional elements not listed. Unless otherwise indicated or the context suggests otherwise, as used herein, “a” or “an” means “at least one” or “one or more.”

1. A beverage maker for preparing hot beverages comprising:
a connector for an external power supply system having a first maximum electrical power;
at least one rechargeable storage unit for electrical energy having a second maximum electrical power that is higher than the first maximum electrical power;
a transformer that is electrically connected to the connector for the external power supply system and to the rechargeable storage unit for electrical energy; and
at least one high-performance electrical consumer for heating water, wherein the at least one high-performance electrical consumer has an electrical connection to the rechargeable storage unit for electrical energy and is supplied with electrical energy by the rechargeable storage unit,
wherein the at least one high-performance electrical consumer for heating water has a minimum electrical power consumption that is higher than the first maximum electrical power.

2. The beverage maker of claim 1, wherein the connector for the external power supply system:
is a connector for an AC power supply system;
is configured, together with the external power supply system, to provide an electrical power per phase of more than 0.5 kW; and/or
is connected to the external power supply system.

3. The beverage maker of claim 1, wherein the beverage maker includes at least one charge regulator that is configured to convert a voltage applied to the connector for the external power supply system such that the at least one rechargeable storage unit can be charged.

4. The beverage maker of claim 3, wherein the charge regulator:
has an electrical connection to the connector for an external power supply system;
has an electrical connection to the rechargeable storage unit for electrical energy; and/or
is configured to convert AC voltage into DC voltage.

5. The beverage maker of claim 1, wherein the rechargeable storage unit for electrical energy:
is configured to provide DC voltage;
is configured to output an electrical power that corresponds to at least 1.5 times the first maximum electrical power;
is configured to provide an electrical power of more than 0.75 kW; and/or
has a storage capacity that is configured to carry out one to five brewing cycles before a recharging of the rechargeable storage unit becomes necessary; and/or
has a storage capacity of more than 0 and less than 100 Wh.

6. The beverage maker of claim 1, wherein the rechargeable storage unit for electrical energy is selected from the group consisting of an electrical rechargeable storage unit, an electrochemical rechargeable storage unit, and any combinations thereof.

7. The beverage maker of claim 1, wherein the at least one rechargeable storage unit is replaceable and/or replaceably arranged in, at, or next to the beverage maker.

8. The beverage maker of claim 1, wherein the beverage maker includes at least one further rechargeable storage unit for electrical energy that:
is electrically connected to the connector for an external power supply system via a further transformer;
is electrically connected to the at least one rechargeable storage unit for electrical energy; and/or
is configured to provide DC voltage;
is configured to output an electrical power that is larger than 0 and less than 75% of the first maximum electrical power;
is configured to output an electrical power that is greater than 0 and less than 1 kW; and/or
has a storage capacity that is higher than the storage capacity of the rechargeable storage unit for electrical energy.

9. The beverage maker of claim 8, wherein the at least one further rechargeable storage unit for electrical energy is selected from the group consisting of an electrical rechargeable storage unit, an electrochemical rechargeable storage unit, and any combinations thereof.

10. The beverage maker of claim 1, wherein the at least one high-performance electrical consumer for heating water
is not supplied with heat energy for heating water by a hot water container;
and/or
has an electrical power consumption that corresponds to at least 1.5 times the first maximum electrical power; and/or
comprises a continuous-flow water heater.

11. The beverage maker of claim 1, wherein the beverage maker has at least one temperature sensor, wherein the at least one temperature sensor:
is arranged within, upstream, and/or downstream of the at least one high-performance electrical consumer for heating water; and/or
is configured to regulate electrical power that is provided to the at least one high-performance electrical consumer for heating water; and/or
is selected from the group consisting of an NTC temperature sensor, a PTC temperature sensor, an IR sensor, a sound velocity sensor, and any combinations thereof.

12. The beverage maker of claim 1, wherein the beverage maker has at least one flow sensor, wherein the at least one flow sensor:
is arranged within, upstream and/or downstream of the at least one high-performance electrical consumer for heating water; and/or
is configured to regulate a volume flow of water in the at least one high-performance electrical consumer for heating water; and/or
is selected from the group comprising a flow meter, a flow rate meter based on ultrasound, a flow rate meter based on MID, and combinations thereof.

13. The beverage maker of claim 1, wherein the beverage maker includes at least one low-voltage consumer.

14. The beverage maker of claim 1, wherein the beverage maker includes at least one control electronic system, wherein the at least one control electronic system is configured to:
communicate the current charge state of the rechargeable storage unit for electrical energy; and/or
receive a forecast for a charge requirement of the rechargeable storage unit for electrical energy from a user and/or to prepare the forecast itself based on statistics; and/or
receive information on a point of time when the rechargeable storage unit for electrical energy should be charged.

15. (canceled)

16. The beverage maker of claim 13, wherein the at least one low-voltage consumer:
is selected from the group consisting of a coffee grinder, a brewer motor for pressing ground coffee, a pump, a valve, a central control unit, an operating unit, and any combinations thereof; and/or
is electrically connected to a further rechargeable storage unit for electrical energy.

17. The beverage maker of claim 14, wherein the at least one control electronic system is configured to:
communicate the current charge state of the rechargeable storage unit for electrical energy to a display of the beverage maker and/or to transmit the current charge state over the internet; and/or
output an information on the forecast for the charge requirement of the rechargeable storage unit for electrical energy on a display of the beverage maker and/or transmit the information on the forecast for the charge requirement over the internet; and/or
receive the information on the point of time when the rechargeable storage unit for electrical energy should be charged from user input and/or from the internet.
